(19) United States
(12) Patent Application Publication
(10) Pub. No.: US 2025/0315616 A1
(43) Pub. Date: Oct. 9, 2025

(54) SYSTEM AND METHOD FOR RESPONDING TO USER QUERIES

(71) Applicant: Yahoo Assets LLC, New York, NY (US)

(72) Inventors: Ilan Ben-Bassat, Tel-Aviv (IL); Sanika Shirwadkar, Milpitas, CA (US); Kenneth Sebastian, Santa Clara, CA (US); Gregory Antonovsky, Brooklyn, NY (US)

(21) Appl. No.: 18/627,506

(22) Filed: Apr. 5, 2024

(51) Int. Cl. G06F 40/279; G06F 16/332

(52) U.S. Cl. CPC G06F 40/279; G06F 16/3328

(57) ABSTRACT

One or more computing devices and/or methods are provided. In an example, a query may be received. A set of content items associated with the query may be identified. A first language model may be used to determine a plurality of sets of contextual information based upon the set of content items. For example, a first set of contextual information of the plurality of sets of contextual information is determined based upon the query and a first content item of the set of content items. A second set of contextual information is determined based upon the query and a second content item of the set of content items. A second language model may be used to determine a response to the query based upon the plurality of sets of contextual information.

### BACKGROUND

Many services, such as websites, applications, etc. may provide platforms for navigating through various media items, datasets, etc. For example, a user may interact with a search interface to find search results for a query.

### SUMMARY

In accordance with the present disclosure, one or more computing devices and/or methods are provided. In an example, a query may be received. A set of content items associated with the query may be identified. A first language model may be used to determine a plurality of sets of contextual information based upon the set of content items. For example, a first set of contextual information of the plurality of sets of contextual information is determined based upon the query and a first content item of the set of content items. A second set of contextual information is determined based upon the query and a second content item of the set of content items. A second language model may be used to determine a response to the query based upon the plurality of sets of contextual information.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method for responding to queries.

FIG. 5A is a component block diagram illustrating an example system for responding to queries, where a first interface is displayed on a first client device.

FIG. 5B is a component block diagram illustrating an example system for responding to queries, where a retrieval tool is used to identify a pool of content items associated with a query.

FIG. 5C is a component block diagram illustrating an example system for responding to queries, where a language model is used to determine an entity associated with a query.

FIG. 5D is a component block diagram illustrating an example system for responding to queries, where a language model is used to determine a relevance classification associated with a content item.

FIG. 5E is a component block diagram illustrating an example system for responding to queries, where a language model is used to determine a set of contextual information associated with a content item.

FIG. 5F is a component block diagram illustrating an example system for responding to queries, where a language model is used to determine a response to a query.

FIG. 5G is a component block diagram illustrating an example system for responding to queries, where a representation of a response to a query is displayed on a first client device.

FIG. 6 is an illustration of a scenario featuring an example non-transitory machine readable medium in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

### 1. Computing Scenario

The following provides a discussion of some types of computing scenarios in which the disclosed subject matter may be utilized and/or implemented.

### 1.1. Networking

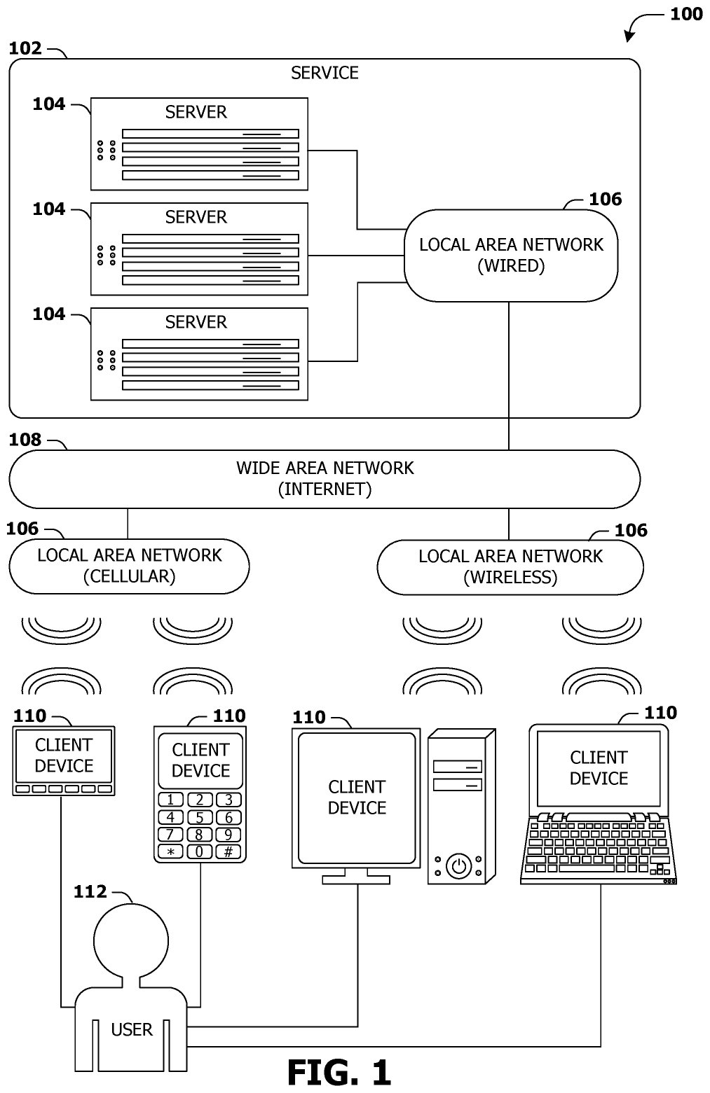

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fiber Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 (and/or via a wired network) provided by a location such as the user's home or workplace (e.g., a WiFi (Institute of Electrical and Electronics Engineers (IEEE) Standard 802.11) network or a Bluetooth (IEEE Standard 802.15.1) personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

### 1.2. Server Configuration

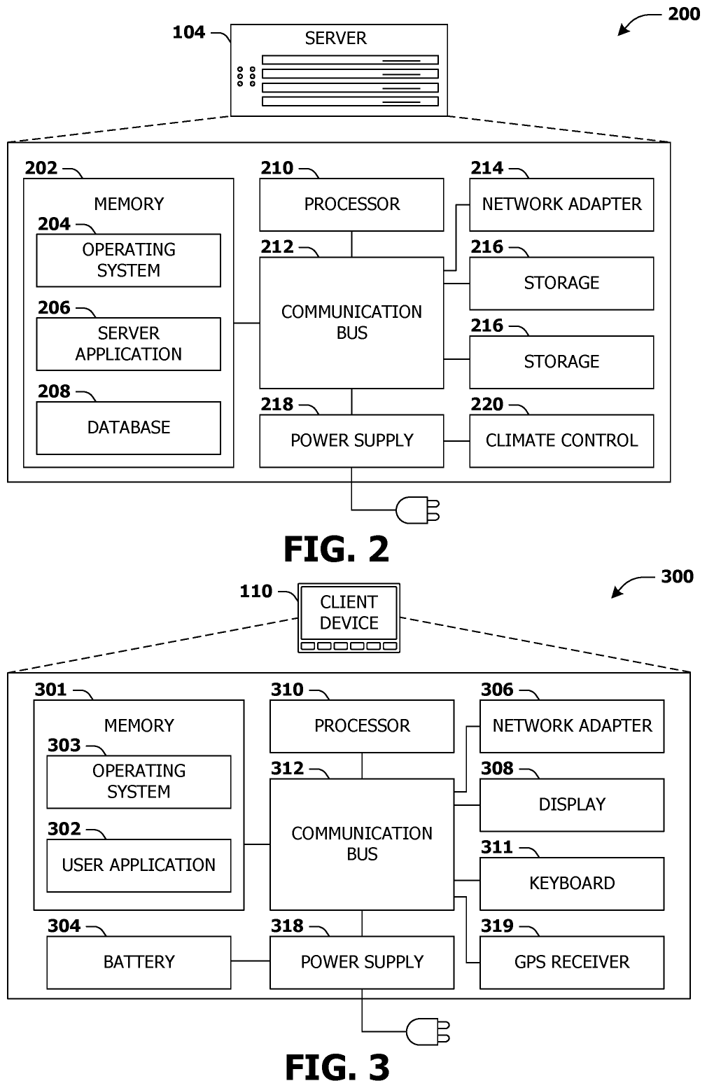

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

### 1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 310 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 311, a mouse, a microphone, a camera, and/or a touch-sensitive component of the display 308; and/or environmental sensors, such as a global positioning system (GPS) receiver 319 that detects the location, velocity, and/or acceleration of the client device 110, a compass, accelerometer, and/or gyroscope that detects a physical orientation of the client device 110. Other components that may optionally be included with the client device 110 (though not shown in the schematic architecture diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

### 2. Presented Techniques

One or more computing devices and/or techniques for responding to queries are provided. In an example, a query may be received from a user. A set of content items relevant to the query may be identified. For example, the set of content items may comprise emails, articles, internet resources, and/or other types of content. A first language model may be used to determine a plurality of sets of contextual information based upon the set of content items. For example, a first set of contextual information of the plurality of sets of contextual information is determined based upon the query and a first content item of the set of content items. A second set of contextual information is determined based upon the query and a second content item of the set of content items. A second language model may be used to determine a response to the query based upon the plurality of sets of contextual information.

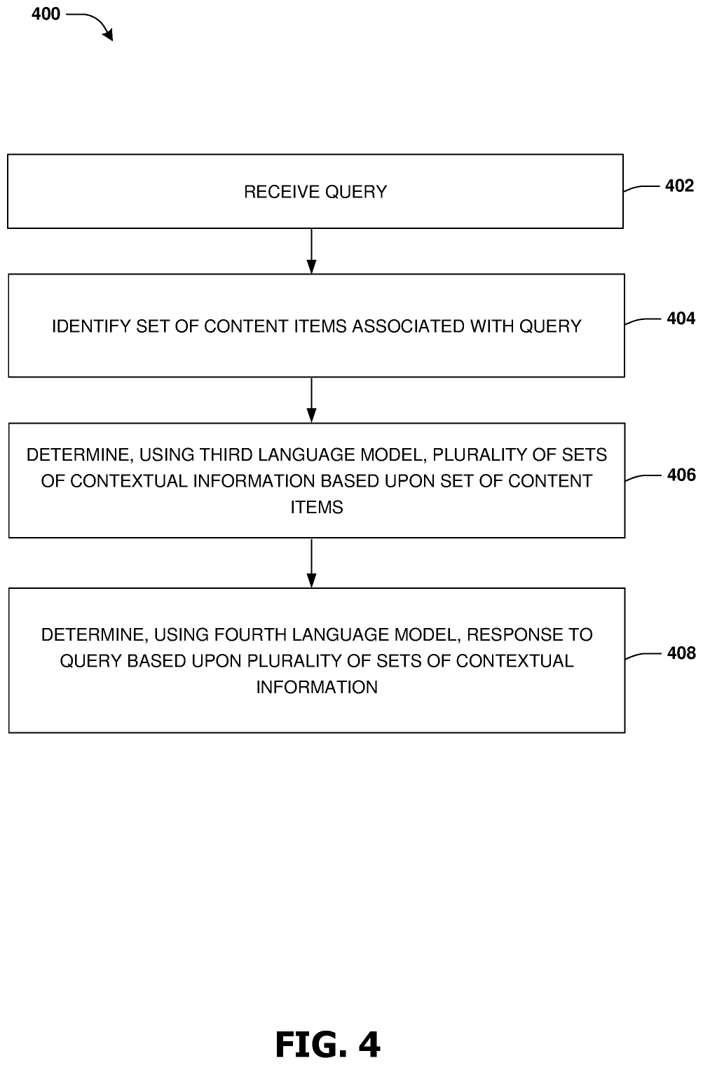

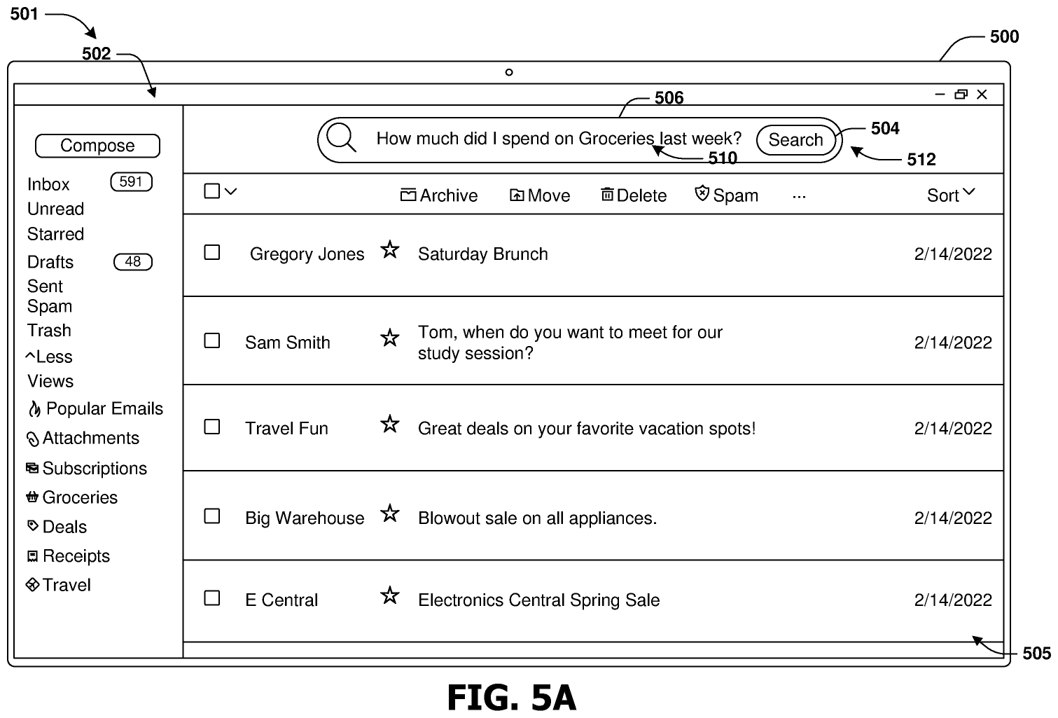

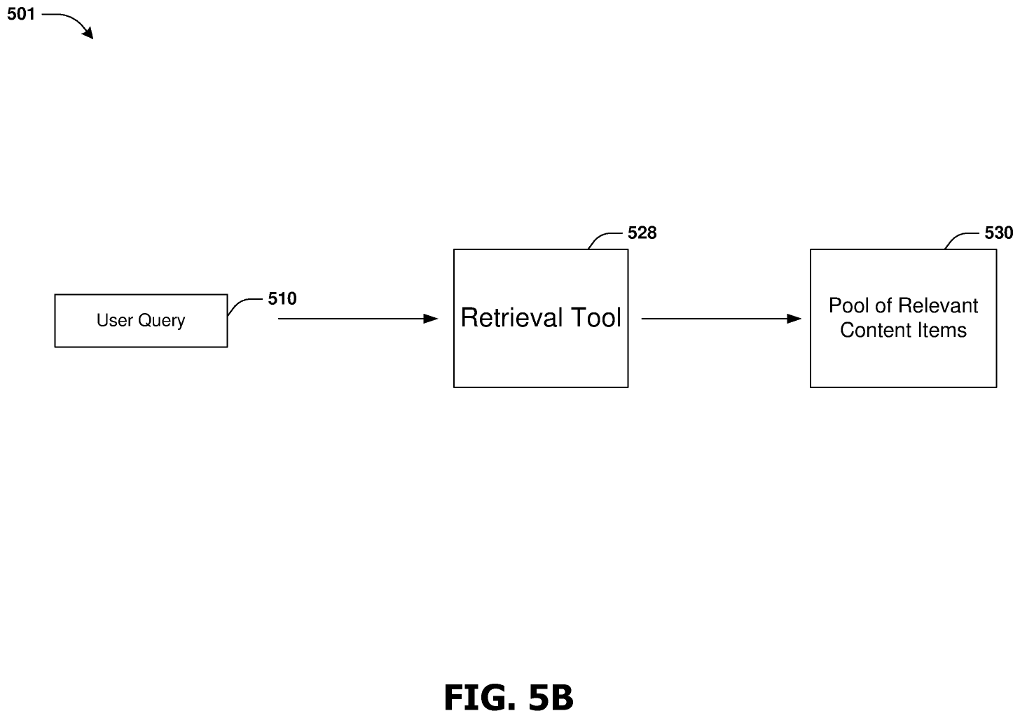

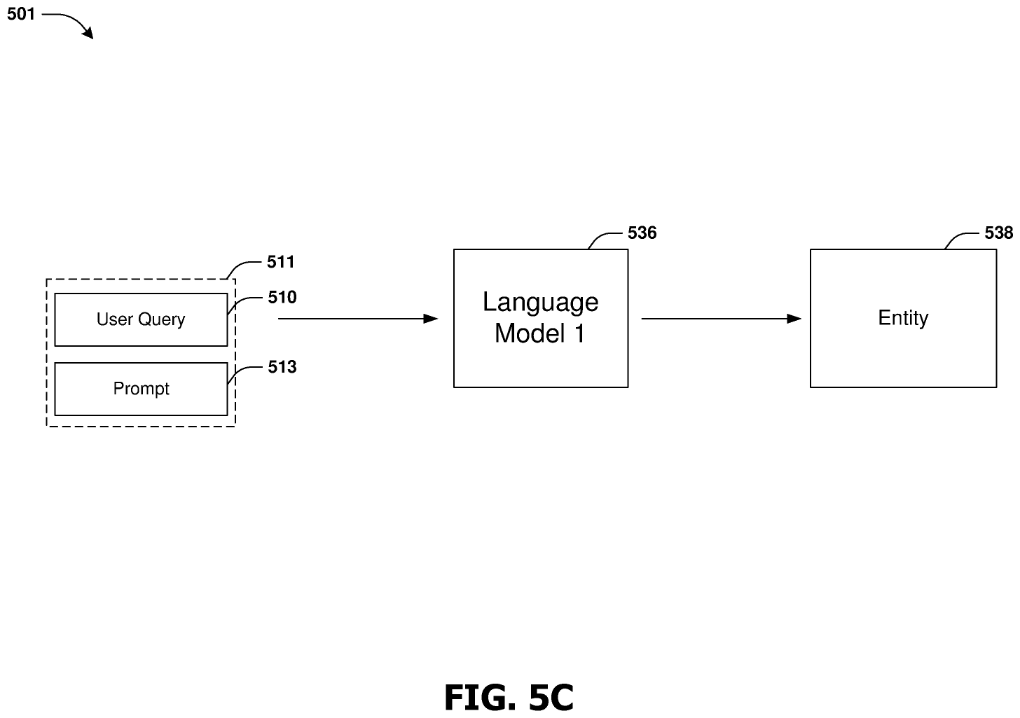

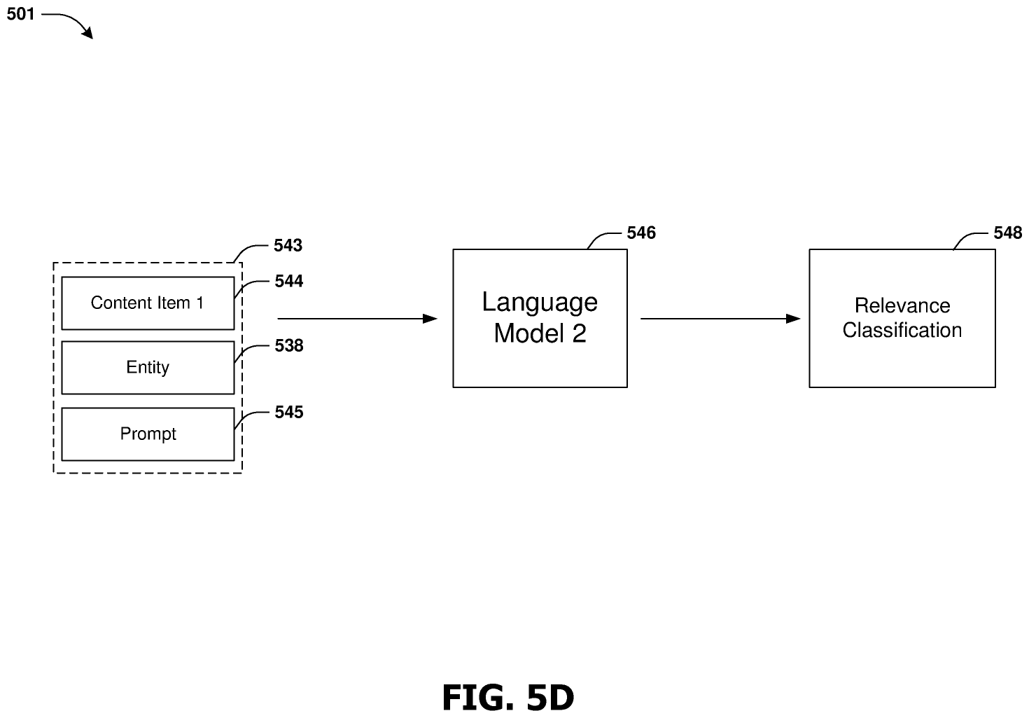

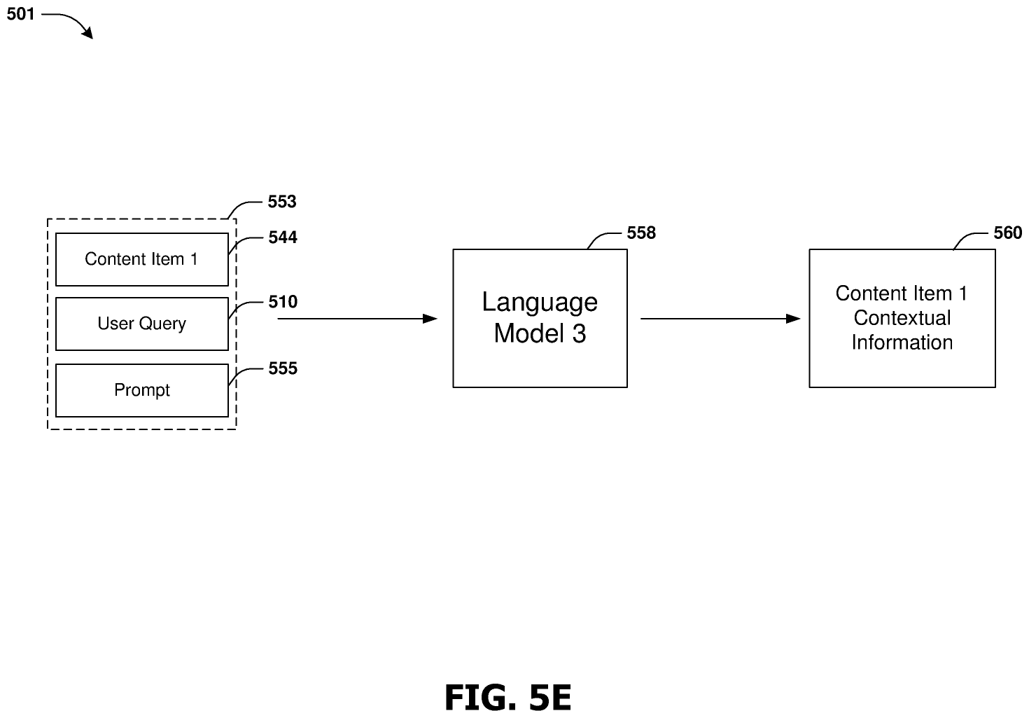

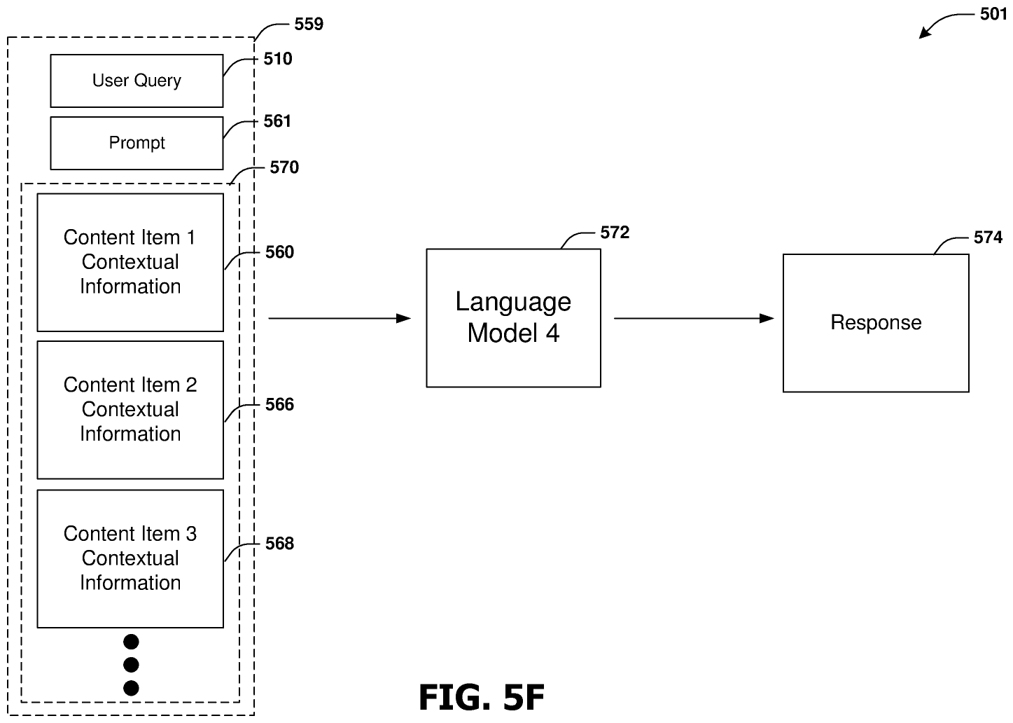

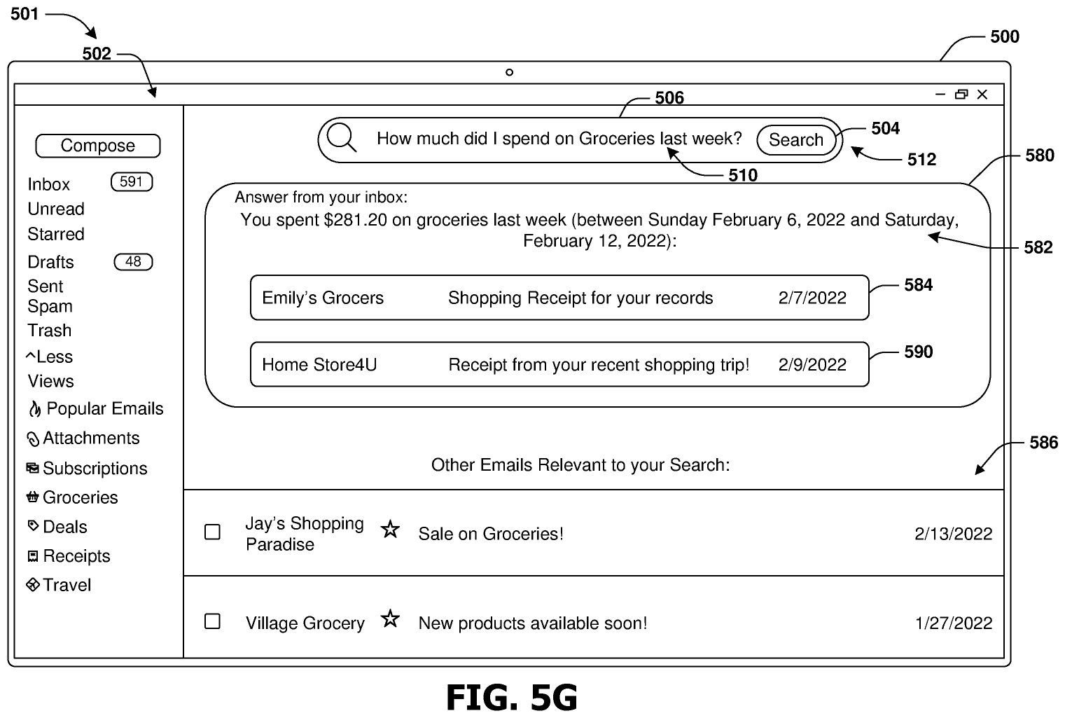

An embodiment of responding to queries is illustrated by an example method 400 of FIG. 4, and is further described in conjunction with a system 501 of FIGS. 5A-5G. In some examples, a content system is provided. A first user, such as user Jill, (and/or a first client device associated with the first user) may access and/or interact with a service, such as an email interface, a browser, software, a website, an application, an operating system, a messaging interface, a music-streaming application, a video application, a news application, etc. that provides a platform for viewing and/or downloading content items (e.g., emails, articles, sets of text, images, audio, videos, etc.) from a server associated with the content system.

At 402, the content system may receive a first query. The first query may be received via a first interface displayed on the first client device. FIG. 5A illustrates the first interface (shown with reference number 502) displayed via the first client device (shown with reference number 500). The first client device 500 may comprise at least one of a phone, a laptop, a computer, a wearable device, a smart device, a television, any other type of computing device, hardware, etc. In an example, the first interface 502 may comprise an email interface. The first interface 502 may be displayed using a browser, a mobile application, etc. of the first client device 500. The first interface 502 may display a list of email items 505. In some examples, email items of the list of email items 505 correspond to emails of an inbox of a first email account associated with the first user. In some examples, in response to a selection of an email item of the list of email items 505, an email associated with the email item may be displayed.

The first interface 502 may comprise a query interface 512 for submitting a query. In some examples, the query interface 512 may comprise a query field 506. For example, the first query (shown with reference number 510) may be entered into the query field 506. In an example, the first query 510 may comprise text (e.g., “How much did I spend on Groceries last week?”). In some examples, the query interface 512 may comprise a search selectable input 504 corresponding to performing a search based upon the first query 510. The content system may receive the first query 510 in response to a selection of the search selectable input 504.

In some examples, the content system may identify a first data structure (for use in responding to the first query 510, for example). In some examples, the first data structure comprises structured data indicative of relations among entities and/or variables. In an example, the first data structure may comprise a relational database. In some examples, the first data structure may comprise a plurality of fields and/or values of the plurality of fields. The first data structure may be stored on one or more data stores (e.g., data storage servers) of the content system.

In some examples, the content system identifies the first data structure based upon the first query 510 and/or user information (e.g., the first email account and/or other user account) associated with the first user and/or the first client device 500. In an example, data that the first user of the first client device 500 is authorized to access may be determined based upon the user information. The first data structure may be identified (for use in responding to the first query 510, for example) based upon a determination that the first user is authorized to access data of the first data structure.

In an example, the first data structure may comprise emails associated with the first email account (e.g., at least one of emails received by the first email account, emails sent by the first email account, emails drafted by the first email account, etc.) and/or data indicative of features associated with the emails. In an example, the first data structure may comprise a set of fields associated with the features comprising at least one of a first field “Time” (e.g., the first field “Time” may be indicative of a time at which an email was sent or received), a second field “Sender” (e.g., the second field “Sender” may be indicative of an email address of a sender of an email), a third field “Recipients” (e.g., the third field “Recipients” may be indicative of one or more email addresses of one or more recipients of an email), a fourth field “Subject” (e.g., the fourth field “Subject” may be indicative of a subject line of an email), a fifth field “Email Body” (e.g., the fifth field “Email Body” may be indicative of a body of an email), etc. The set of fields may be populated with values for emails associated with the first email account. For example, the first field “Time” may be populated with a first time for a first email associated with the first email account (e.g., the first time may correspond to a timestamp corresponding to when the first email was sent or received), a second time for a second email associated with the first email account, etc. The second field “Sender” may be populated with a first sender indication for the first email (e.g., an email address of a sender of the first email), a second sender indication for the second email, etc. The third field “Recipients” may be populated with a first recipient indication for the first email (e.g., one or more email addresses of one or more recipients of the first email), a second recipient indication for the second email, etc.

In some examples, in response to receiving the first query 510, a pool of content items associated with the first query 510 may be identified. FIG. 5B illustrates use of a content item retrieval tool 528 to identify the pool of content items (shown with reference number 530). In some examples, the content item retrieval tool 528 may analyze the first data structure to identify the pool of content items 530. In some examples, the content item retrieval tool 528 may perform a vector search and/or a keyword search on the first data structure and/or one or more other resources (e.g., servers, databases, internet resources, etc.) to identify the pool of content items 530. In some examples, the content item retrieval tool 528 may use a search engine (e.g., a web search engine designed to search for information throughout the Internet) to perform a search (e.g., an internet search) according to the first query 510 to determine a plurality of search results corresponding to a plurality of internet resources associated with the first query 510, and/or may include the plurality of internet resources in the pool of content items 530. In some examples, the plurality of search results may be generated based upon a determination that one or more parts of the first query 510 matches one or more parts of each internet resource of the plurality of internet resources. In some examples, the content item retrieval tool 528 includes a content item (e.g., at least one of an email, an article, an internet resource, a text snippet, a video, an image, an audio file, etc.) in the pool of content items 530 based upon a determination that the content item is relevant to a keyword (e.g., “Groceries”, etc.) in the first query 510. The content item retrieval tool 528 may include a content item (indicated by the first data structure, for example) in the pool of content items 530 based upon a determination that the content item is relevant to the first query 510.

In some examples, the pool of content items 530 may correspond to a subset of a second pool of content items determined using the content item retrieval tool 528 for the first query 510. For example, the second pool of content items may be ranked based upon levels of relevance to the first query 510. The pool of content items 530 may comprise a set of top N ranked content items among the second pool of content items. N may correspond to a maximum number of content items to include in the pool of content items 530. In some examples, N may be set to a predefined value and/or may be based upon a processing capacity of the content system.

A content item of the pool of content items 530 may comprise an email associated with the first email account. Alternatively and/or additionally, a content item of the pool of content items 530 may comprise an internet resource (e.g., a web page and/or at least a portion of an application, such as at least one of a web application, a mobile application, etc.). Alternatively and/or additionally, a content item of the pool of content items 530 may comprise an article (e.g., news articles, educational articles, research papers, sports articles, informational articles, blogs, etc.). Other types of content items of the pool of content items 530 are contemplated. For example, a content item of the pool of content items 530 may comprise at least one of a video, a blog, a social media post, etc.

The content system may determine a first entity associated with the first query 510. In an example, the first entity may correspond to a main theme and/or a salient entity of the first query 510. For example, the first entity may be indicative of one or more topics of the first query 510. In some examples, the first entity may correspond to (i) a place (e.g., country, city, geographic location, etc.), (ii) a person (e.g., a person of a particular location, a person with a particular occupation, a politician, a celebrity, a socialite, etc.), (iii) a thing (e.g., device, natural object, etc.), (iv) an organization, (v) a company, (vi) a stock symbol, (vii) a ticker symbol, (viii) an idea, (ix) a system, (x) an object (e.g., an abstract object and/or a physical object), (xi) an event such as a historical event and/or a current event, (xii) a concept, and/or (xiii) other type of entity. In an example in which the first query 510 comprises text “How much did I spend on Groceries last week?”, the content system may determine the first entity to be at least one of “groceries”, “shopping”, “spend”, etc. In an example in which the first query 510 comprises text “When is my next flight?”, the content system may determine the first entity to be “flight information”.

FIG. 5C illustrates use of a first language model 536 to determine the first entity (shown with reference number 538). In an example, the first language model 536 may comprise a large language model (LLM). In some examples, the first language model 536 may be trained using a corpus (e.g., a text corpus). In some examples, the first language model 536 comprises a knowledge base (e.g., a database of resources) comprising at least one of one or more dictionaries, one or more lists of terms, one or more encyclopedias, one or more online encyclopedias, one or more news channel resources, one or more news websites, one or more websites, one or more books, one or more research articles, one or more research article databases, one or more informational databases, etc.

In some examples, the first language model 536 may determine the first entity 538 based upon a first set of information 511 provided to the first language model 536. In some examples, the first set of information 511 comprises the first query 510 and/or a first prompt 513. In some examples, the first prompt 513 may comprise an instruction to provide an indication of the first entity 538 (e.g., main theme, salient entity, one or more topics, etc.) associated with the first query 510. Accordingly, in response to the first set of information 511, the first language model 536 may (i) determine the first entity 538 based upon the first query 510 and/or (ii) output an indication of the first entity 538. In an example, the first prompt 513 may comprise: <You are a helpful tool for question answering. Extract the main entity the query is asking about.>. In an example in which the first query 510 comprises “When was my last meeting with Andrea?”, the first language model 536 may determine the first entity 538 to be “meeting with Andrea”.

At 404, the content system may identify a first set of content items associated with the first query 510. In some examples, the content system may (i) use the first entity 538 to determine relevance classifications associated with content items of the pool of content items 530 and/or (ii) use the relevance classifications to select the first set of content items from the pool of content items 530. FIG. 5D illustrates use of a second language model 546 to determine a first relevance classification 548 associated with a first content item 544 of the pool of content items 530. In an example, the second language model 546 may comprise a large language model. In some examples, the second language model 546 may be trained using a corpus (e.g., a text corpus). In some examples, the second language model 546 comprises a knowledge base (e.g., a database of resources) comprising at least one of one or more dictionaries, one or more lists of terms, one or more encyclopedias, one or more online encyclopedias, one or more news channel resources, one or more news websites, one or more websites, one or more books, one or more research articles, one or more research article databases, one or more informational databases, etc. In some examples, the second language model 546 is the same as the first language model 536. Alternatively and/or additionally, the second language model 546 may be different than the first language model 536.

In some examples, the second language model 546 may determine the first entity 538 based upon a second set of information 543 provided to the second language model 546. In some examples, the second set of information 543 is indicative of the first content item 544 (e.g., at least one of an email, an article, an internet resource, a video, an image, an audio file, etc.), the first entity 538 and/or a second prompt 545. In some examples, the second prompt 545 may comprise an instruction to provide an indication of whether the first content item 544 is relevant to the first entity 538. Accordingly, in response to the second set of information 543, the second language model 546 may (i) determine the first relevance classification 548 indicative of whether the first content item 544 is relevant to the first entity 538 and/or (ii) output an indication of the first entity 538.

In some examples, the content system may select the first content item 544 for inclusion in the first set of content items in response to the first relevance classification 548 indicating that the first content item 544 is relevant to the first entity 538. In some examples, the content system may not include the first content item 544 in the first set of content items (and/or the content system may exclude the first content item 544 from the first set of content items) in response to the first relevance classification 548 indicating that the first content item 544 is not relevant to the first entity 538. Other relevance classifications associated with other content items of the pool of content items 530 may be determined using one or more of the techniques provided herein with respect to determining the first relevance classification 548 associated with the first content item 544. In some examples, for each content item of one, some and/or all of the pool of content items 530, the content system may (i) determine a relevance classification (e.g., the first relevance classification 548) based upon the content item and the first entity 538, and/or (ii) determine whether to include the content item in the first set of content items.

At 406, the content system may determine a plurality of sets of contextual information based upon the first set of content items. The plurality of sets of contextual information may be determined using a third language model. For each content item of one, some and/or all of the first set of content items, the content system may determine a set of contextual information based upon the content item and the first query 510. For example, the plurality of sets of contextual information may comprise (i) a first set of contextual information determined based upon the first query 510 and/or the first content item 544 of the first set of content items, (ii) a second set of contextual information determined based upon the first query 510 and/or a second content item of the first set of content items, (ii) a third set of contextual information determined based upon the first query 510 and/or a third content item of the first set of content items, and/or (iv) one or more other sets of contextual information determined based upon the first query 510 and/or one or more other content items of the first set of content items.

FIG. 5E illustrates use of the third language model (shown with reference number 558) to determine the first set of contextual information (shown with reference number 560). In an example, the third language model 558 may comprise a large language model. In some examples, the third language model 558 may be trained using a corpus (e.g., a text corpus). In some examples, the third language model 558 comprises a knowledge base (e.g., a database of resources) comprising at least one of one or more dictionaries, one or more lists of terms, one or more encyclopedias, one or more online encyclopedias, one or more news channel resources, one or more news websites, one or more websites, one or more books, one or more research articles, one or more research article databases, one or more informational databases, etc. In some examples, the third language model 558 is the same as the first language model 536 and/or the second language model 546. Alternatively and/or additionally, the third language model 558 may be different than the first language model 536 and/or the second language model 546.

In some examples, the third language model 558 may determine the first set of contextual information 560 based upon a third set of information 553 provided to the third language model 558. In some examples, the third set of information 553 is indicative of the first content item 544, the first query 510 and/or a third prompt 555. In some examples, the third prompt 555 may comprise an instruction to use the first content item 544 to provide a response to the first query 510. Accordingly, in response to the third set of information 553, the third language model 558 may (i) analyze the first query 510 to derive a question and/or request posed by the first query 510, (ii) analyze the first content item 544 to determine an answer to the question and/or request posed by the first query 510, and/or (iii) generate the first set of contextual information 560 to be indicative of the answer. In an example, the third language model 558 may generate the first set of contextual information 560 (e.g., the answer to the question and/or request posed by the first query 510) to be indicative of contextual information associated with the first query 510 (e.g., the contextual information may comprise one or more facts that are relevant to the first query 510). Alternatively and/or additionally, the third prompt 555 may comprise an instruction to extract, from the first content item 544, the contextual information (e.g., the one or more facts that are relevant to the first query 510). For example, the third language model 558 may analyze the first content item 544 to derive the contextual information, and/or may generate the first set of contextual information 560 to be indicative of the one or more facts).

In some examples, the third language model 558 may determine the second set of contextual information (associated with the second content item of the first set of content items) based upon a set of information provided to the third language model 558. In some examples, the set of information is indicative of the second content item, the first query 510 and/or a prompt. In some examples, the prompt may comprise an instruction to use the second content item to provide a response to the first query 510. Accordingly, in response to the set of information, the third language model 558 may (i) analyze the first query 510 to derive a question and/or request posed by the first query 510, (ii) analyze the second content item to determine an answer to the question and/or request posed by the first query 510, and/or (iii) generate the second set of contextual information to be indicative of the answer. In an example, the third language model 558 may generate the second set of contextual information (e.g., the answer to the question and/or request posed by the first query 510) to be indicative of contextual information associated with the first query 510 (e.g., the contextual information may comprise one or more facts that are relevant to the first query 510). Alternatively and/or additionally, the prompt may comprise an instruction to extract, from the second content item, the contextual information (e.g., the one or more facts that are relevant to the first query 510). For example, the third language model 558 may analyze the second content item to derive the contextual information, and/or may generate the second set of contextual information to be indicative of the one or more facts).

Other sets of contextual information of the plurality of sets of contextual information may be determined using one or more of the techniques provided herein with respect to determining the first set of contextual information 560 and/or the second set of contextual information.

In some examples, the first set of contextual information 560 and the second set of contextual information are determined concurrently. For example, the first set of contextual information 560 and the second set of contextual information may be determined via parallel calls (e.g., parallel LLM calls) to the third language model 558. In some examples, performing parallel processes using the third language model 558 to concurrently determine sets of contextual information of the plurality of sets of contextual information using the third language model 558 provides for increased speed with which the plurality of sets of contextual information are determined, thereby allowing the content system to process queries and/or provide responses with increased speed and/or efficiency.

In some embodiments, content items of the may be stacked in batches of k content items per prompt, where the third language model 558 may be used to at least one of (i) process a first batch of k content items (e.g., the first batch of k content items may comprise at least one of the first content item 544, the second content item, etc.) using the third prompt 555 to determine a first batch of sets of contextual information (e.g., the first batch of sets of contextual information may comprise at least one of the first set of contextual information 560, the second set of contextual information, etc.), (ii) process a second batch of k content items using a fifth prompt to determine a second batch of sets of contextual information, etc. The plurality of sets of contextual information may comprise at least one of the first batch of sets of contextual information, the second batch of sets of contextual information, etc. In some examples, k may be set to a predefined value. Higher values of k may increase an amount of LLM calls to the third language model 558 (and thereby increase cost of determining the plurality of sets of contextual information) and/or lower values of k may increase model performance of the third language model 558. In some examples, k may be optimized to balance model performance of the third language model 558 and cost of LLM calls.

At 408, the content system may determine a first response to the first query 510 based upon the plurality of sets of contextual information. The first response may be determined using a fourth language model. FIG. 5F illustrates use of the fourth language model (shown with reference number 572) to determine the first response (shown with reference number 574). In an example, the fourth language model 572 may comprise a large language model. In some examples, the fourth language model 572 may be trained using a corpus (e.g., a text corpus). In some examples, the fourth language model 572 comprises a knowledge base (e.g., a database of resources) comprising at least one of one or more dictionaries, one or more lists of terms, one or more encyclopedias, one or more online encyclopedias, one or more news channel resources, one or more news websites, one or more websites, one or more books, one or more research articles, one or more research article databases, one or more informational databases, etc. In some examples, the fourth language model 572 is the same as the first language model 536, the second language model 546 and/or the third language model 558. Alternatively and/or additionally, the fourth language model 572 may be different than the first language model 536, the second language model 546 and/or the third language model 558.

In some examples, the fourth language model 572 may determine the first response 574 based upon a fourth set of information 559 provided to the fourth language model 572. In some examples, the fourth set of information 559 is indicative of a first contextual information profile 570, the first query 510 and/or a fourth prompt 561. In some examples, the content system may aggregate the plurality of sets of contextual information to generate the first contextual information profile 570. The first contextual information profile 570 may comprise the plurality of sets of contextual information and/or reference identifiers associated with the plurality of sets of contextual information. The reference identifiers may be indicative of content items associated with the plurality of sets of contextual information. For example, the first contextual information profile 570 may comprise at least one of (i) the first set of contextual information 560 associated with the first content item 544, (ii) a first reference identifier indicating that the first set of contextual information 560 is associated with the first content item 544, (iii) the second set of contextual information (shown with reference number 566 in FIG. 5F) associated with the second content item, (iv) a second reference identifier indicating that the second set of contextual information 566 is associated with the second content item, (v) the third set of contextual information (shown with reference number 568 in FIG. 5F) associated with the third content item, (vi) a third reference identifier indicating that the third set of contextual information 568 is associated with the third content item, etc.

In some examples, the fourth prompt 561 may comprise an instruction to use the first contextual information profile 570 to provide a response to the first query 510. Accordingly, in response to the fourth set of information 559, the fourth language model 572 may (i) analyze the first query 510 to derive a question and/or request posed by the first query 510, (ii) analyze the first contextual information profile 570 to determine an answer to the question and/or request posed by the first query 510, and/or (iii) generate the first response 574 to be indicative of the answer. In some examples, the fourth prompt 561 may comprise an instruction to provide, in the first response 574, one or more indications of one or more reference identifiers of one or more sets of contextual information used to generate the first response 574.

In an example, the first query 510 comprises text “How much did I spend on Groceries last week?”. The first content item 544 may comprise a first payment confirmation email sent to the first email account by a first shopping platform (e.g., an online shopping platform, a physical store, a grocery store, etc.). The first payment confirmation email may comprise a first list of purchased items, first prices of the purchased items, and/or a first total amount spent for the purchased items. The third language model 558 may analyze the first payment confirmation email to determine one or more facts relevant to the first query 510 and/or may generate the first set of contextual information 560 to be indicative of the one or more facts (e.g., the first set of contextual information 560 may include the first list of purchased items, the first prices and/or the first total amount). The second content item may comprise a second payment confirmation email sent to the first email account by a second shopping platform (e.g., an online shopping platform, a physical store, a grocery store, etc.). The second payment confirmation email may comprise a second list of purchased items, second prices of the purchased items, and/or a second total amount spent for the purchased items. The third language model 558 may analyze the second payment confirmation email to determine one or more facts relevant to the first query 510 and/or may generate the second set of contextual information 566 to be indicative of the one or more facts (e.g., the second set of contextual information 566 may include the second list of purchased items, the second prices and/or the second total amount). Thus, the first contextual information profile 570 may be indicative of facts (e.g., concise facts) relevant to the first query 510 (e.g., the facts may include at least one of items purchased by the first user, prices of the items, and/or total amounts of purchases by the first user). The fourth language model 572 may use the (concise) facts indicated by the first contextual information profile 570 to determine the first response 574. For example, total amounts of purchases indicated by the first contextual information profile 570 may be summed to determine an amount spent on groceries during a time period (e.g., a week corresponding to “last week”). The first total amount spent indicated by the first set of contextual information 560, the second total amount spent indicated by the second set of contextual information 566, and/or one or more other amounts indicated by one or more other sets of contextual information may be summed to determine the amount spent on groceries during the time period. The first response 574 may be generated to comprise (i) an indication of the amount spent on groceries during the time period and/or (ii) an indication of one or more reference identifiers associated with one or more sets of contextual information used to determine the amount spent on groceries during the time period. For example, the one or more reference identifiers indicated by the first response 574 may comprise at least one of (i) the first reference identifier associated with the first content item 544 based upon the first set of contextual information 560 (e.g., the first total amount spent) having been used to determine the amount spent on groceries during the time period, (ii) the second reference identifier associated with the second content item based upon the second set of contextual information 566 (e.g., the second total amount spent) having been used to determine the amount spent on groceries during the time period, etc.

In an example, the first query 510 comprises text “When is my next flight?”. The first content item 544 may comprise a first flight confirmation email sent to the first email account by a first flight agent (e.g., an online travel agency, a physical travel agency, an airline, etc.). The first flight confirmation email may comprise first flight information for a first flight (e.g., first departure time, first departure location, first arrival time, first arrival location, etc.). The third language model 558 may analyze the first flight confirmation email to determine one or more facts relevant to the first query 510 and/or may generate the first set of contextual information 560 to be indicative of the one or more facts (e.g., the first set of contextual information 560 may include the first flight information for the first flight). The second content item may comprise a second flight confirmation email sent to the first email account by a second flight agent (e.g., an online travel agency, a physical travel agency, an airline, etc.). The second flight confirmation email may comprise second flight information for a second flight (e.g., second departure time, departure location, arrival time, arrival location, etc.). The third language model 558 may analyze the second flight confirmation email to determine one or more facts relevant to the first query 510 and/or may generate the second set of contextual information 566 to be indicative of the one or more facts (e.g., the second set of contextual information 566 may include the second flight information for the second flight). Thus, the first contextual information profile 570 may be indicative of facts (e.g., concise facts) relevant to the first query 510 (e.g., the facts may include flight information of flights of the first user, such as departure times, departure locations, arrival times and/or arrival locations). The fourth language model 572 may use the (concise) facts indicated by the first contextual information profile 570 to determine the first response 574. For example, times (e.g., departure times and/or arrival times) of flights indicated by the first contextual information profile 570 may be compared to identify a soonest flight, of the flights, in the future. In an example, the soonest flight may be the first flight (e.g., the first flight may be before the second flight and/or other flights scheduled for the first user). The first response 574 may be generated to comprise (i) an indication of the first flight (e.g., the first user's next flight) and/or (ii) an indication of the first reference identifier associated with the first content item 544 (e.g., the first flight confirmation email) associated with the first flight.

In some examples, the content system may provide a representation of the first response 574 for display on the first client device 500. For example, the representation of the first response 574 may be displayed via the first interface 502. FIG. 5G illustrates the representation (shown with reference number 580) of the first response 574 being displayed via the first interface 502. In some examples, the representation 580 may comprise (i) an indication 582 of the amount spent on groceries during the time period and/or (ii) one or more reference items corresponding to one or more reference identifiers indicated by the first response 574. For example, the one or more reference items may comprise a first reference item 584 corresponding to the first reference identifier associated with the first content item 544 (e.g., the first payment confirmation email) and/or a second reference item 590 corresponding to the second reference identifier associated with the second content item (e.g., the second payment confirmation email). For example, the first reference item 584 may comprise an indication of a contact (e.g., “Emily's Grocers”), an indication of a subject line of the first payment confirmation email (e.g., Shopping Receipt for your records), and/or an indication of a time (e.g., a date) associated with the first payment confirmation email (e.g., “2/7/2022”). In some examples, in response to a selection of the first reference item 584, the first payment confirmation email may be displayed via the first interface 502.

In some examples, the content system may provide a list of search results 586 associated with the first query 510 for display on the first client device 500. In some examples, the content system may perform a keyword search based upon the first query 510 to generate the list of search results 586. In some examples, the content system includes an email item in the list of search results 586 based upon a determination that an email corresponding to the email item is relevant to a keyword (e.g., “Groceries”, “week”, “spend”, etc.) in the first query 510.

In accordance with some embodiments of the present disclosure, a retrieval augmented generation (RAG) pipeline is implemented with (i) a retrieval module (e.g., comprising the content item retrieval tool 528) configured to retrieve the pool of content items 530, (ii) a generation module (e.g., comprising the fourth language model 572) configured to generate the first response 574 to the first query 510, and/or (iii) an (intermediate) extraction module (between the retrieval module and the generation module) configured to (A) validate relevancy of the pool of content items 530 (via filtering based upon relevance classifications, for example) and/or (B) extract concise and/or relevant facts to be compiled in the first contextual information profile 570 for use in generating the first response 574 (e.g., the extraction module may comprise the first language model 536, the second language model 546 and/or the third language model 558). Thus, in accordance with the present disclosure, the extraction module may transform the pool of content items 530 retrieved by the retrieval module to more concise and/or useful information (e.g., the first contextual information profile 570) that can be used by the generation module to more efficiently and/or accurately generate the first response 574 to the first query 510. Implementation of the techniques provided herein may circumvent long-context problems, improve the quality of responses to queries and/or handle complex aggregation of information more efficiently.

In some examples, each language model of one, some and/or all language models of the present disclosure (e.g., the first language model 536, the second language model 546, the third language model 558 and/or the fourth language model 572) may comprise at least one of a generative artificial intelligence (AI) tool, a neural network, a tree-based model, a machine learning model used to perform linear regression, a machine learning model used to perform logistic regression, a decision tree model, a support vector machine (SVM), a Bayesian network model, a k-Nearest Neighbors (k-NN) model, a K-Means model, a random forest model, a machine learning model used to perform dimensional reduction, a machine learning model used to perform gradient boosting, etc.

It may be appreciated that using one or more of the techniques provided herein may provide for generating the first response 574 to the first query 510 more efficiently and/or quickly, such as due, at least in part, to providing the fourth language model 572 with the first contextual information profile 570 for use in generating the first response 574 such that the fourth language model 572 may generate the first response 574 based upon the first contextual information profile 570 (determined to be relevant to the first query 510, for example) without having to process an entirety of the first set of content items and/or the pool of content items 530. Thus, in accordance with some embodiments, the content system may provide a question-answering service that is more efficient and/or faster than some systems that do not derive contextual information (e.g., the first contextual information profile 570) relevant to the first query 510 and/or may instead provide an entirety of a set of content items (e.g., an entirety of the first set of content items and/or the pool of content items 530) to a language model and/or task the language model with processing the entirety of the set of content items in order to determine a response to a user query.

It may be appreciated that using one or more of the techniques provided herein may provide for generating the first response 574 to the first query 510 with increased accuracy, such as due, at least in part, to providing the fourth language model 572 with the first contextual information profile 570 for use in generating the first response 574 such that the fourth language model 572 may generate the first response 574 based upon the first contextual information profile 570 (determined to be relevant to the first query 510, for example) without having to process an entirety of the first set of content items and/or the pool of content items 530. For example, some systems may (i) provide a language model and/or a natural language processing (NLP) algorithm with a set of content items (e.g., the first set of content items and/or the pool of content items 530) and/or (ii) task the language model and/or the NLP algorithm with determining a response to a query based upon the set of content items. Such systems may obtain incorrect responses since the set of content items may be too large and/or may comprise too much information for the language model and/or the NLP algorithm to be able to process the set of content items and/or correctly derive the response. In accordance with some embodiments, the first contextual information profile 570 may comprise less data than the entirety of the set of content items, and/or data of the first contextual information profile 570 may include data relevant to the first query 510 and/or exclude data that is irrelevant to the first query 510. Thus, in accordance with one or more of the techniques provided herein, the first response 574 may be determined with increased accuracy, such as due, at least in part, to the fourth language model 572 being provided with the first contextual information profile 570 (as opposed to being provided with the entirety of the first set of content items and/or the pool of content items 530, for example).

It may be appreciated that using one or more of the techniques provided herein may provide for generating the first response 574 to the first query 510 with improved operational efficiency, such as due, at least in part, to using determined relevance classifications associated with the pool of content items 530 to filter at least some (irrelevant) content items from the pool of content items 530 to derive the first set of content items based upon which the first contextual information profile 570 (used to generate the first response 574 to the first query 510) is determined, which allows the content system to focus on relevant content and/or disregard irrelevant content (such that less content needs to be processed by the fourth language model 572 to generate the first response 574, for example). Alternatively and/or additionally, filtering (irrelevant) content items from the pool of content items 530 (according to the relevance classifications) allows the content system to include an increased quantity of content items in the pool of content items 530 (e.g., the pool of content items 530 may comprise a larger share of the second pool of content items) while satisfying the processing capacity of the content system (since irrelevant content items are filtered from the pool of content items 530 according to the relevance classifications, for example, thereby reducing an amount of data to be processed), thereby providing for improved accuracy of the first response 574 (e.g., the improved accuracy of the first response 574 may be due, at least in part, to enlarging the pool of content items 530 considered by the content system in generating the first response 574 and/or alleviating a potential problem of missing information).

It may be appreciated that the disclosed subject matter may assist a user in determining an answer to a question and/or request posed by a user query (e.g., the first query 510).

Implementation of at least some of the disclosed subject matter may lead to benefits including a reduction in screen space and/or an improved usability of a display (e.g., of a client device) (e.g., as a result of providing the first response 574 that may represent an answer to a question and/or request posed by the first query 510, wherein the user may not be required to navigate through multiple items (e.g., email items), multiple web pages and/or open various tabs and/or windows to access the requested information and/or the user may not be required to navigate away to a different page, and/or manually sift through online information, thereby saving time and effort, etc.).

Alternatively and/or additionally, implementation of at least some of the disclosed subject matter may lead to benefits including less manual effort (e.g., as a result of generating the first response 574 automatically, wherein manual editing to produce the first response 574 is not required).

In some examples, the first client device 500 is configured to display a menu listing one or more features (e.g., selectable features) of the content system. The one or more features may comprise at least one of a search feature, a content feature, a messaging feature, a social media feed feature, an email feature, etc. In an example, in response to a selection of the search feature, the search feature may provide one or more resources for using a search engine of the content system to search for content. In an example, in response to a selection of the content feature, the content feature may provide one or more resources for displaying and/or engaging with content items (e.g., videos, images, audio files, news articles, etc.). In response to a selection of the messaging feature, the messaging feature may provide one or more resources (e.g., data, an interface, etc.) for displaying and/or facilitating messaging conversations (e.g., private messaging conversations and/or public messaging conversations) between users of the content system (e.g., users of the content system may send messages to each other using the messaging feature of the content system). In response to a selection of the social media feed feature, the social media feed feature may provide one or more resources (e.g., data, an interface, etc.) for displaying social media posts and/or comments on a social media platform. In response to a selection of the email feature, the email feature may provide one or more resources (e.g., data, an interface such as the first interface 502, etc.) for displaying emails and/or allowing the first user to compose new emails and/or reply to emails. In some examples, the client device is configured to display a content platform application summary that can be reached directly from the menu, wherein the content platform application summary displays a limited list of data offered within the one or more features. In some examples, each of the data in the limited list of data is selectable to launch the respective feature (of the one or more features) and enable the selected data to be seen within the respective feature. In some examples, the content platform application summary is displayed while the one or more features are in an un-launched and/or unopened state.

In some examples, one, some or all acts of the present disclosure are implemented using a cognitive system (e.g., a cognitive computing system) of the content system. The cognitive system may comprise the content item retrieval tool 528, the first language model 536, the second language model 546, the third language model 558, the fourth language model 572, and/or a question-answering pipeline (comprising the content item retrieval tool 528, the first language model 536, the second language model 546, the third language model 558 and/or the fourth language model 572, for example) for providing responses (e.g., the first response 574) to user queries (e.g., the first query 510). A cognitive system may be a specialized computer system, and/or a set of computer systems, configured with hardware and/or software logic (in combination with hardware logic upon which the software executes) to emulate human cognitive functions. The cognitive system may apply human-like characteristics to conveying and manipulating ideas which, when combined with the inherent strengths of digital computing, may solve problems with high accuracy and resilience on a large scale. The cognitive system may perform one or more computer-implemented cognitive operations that approximate a human thought process as well as enable people and machines to interact in a more natural manner so as to extend and magnify human expertise and cognition. The cognitive system may comprise artificial intelligence logic, such as NLP based logic, for example, and machine learning logic, which may be provided as specialized hardware, software executed on hardware, or any combination of specialized hardware and software executed on hardware. The logic of the cognitive system implements the cognitive operation(s), examples of which include, but are not limited to, question answering, identification of related concepts within different portions of content in a corpus, intelligent search algorithms, such as Internet web page searches, for example, medical diagnostic and treatment recommendations, and other types of recommendation generation, e.g., items of interest to a particular user, potential new contact recommendations, or the like.

In some examples, at least some of the disclosed subject matter may be implemented on a client device, and in some examples, at least some of the disclosed subject matter may be implemented on a server (e.g., hosting a service accessible via a network, such as the Internet).

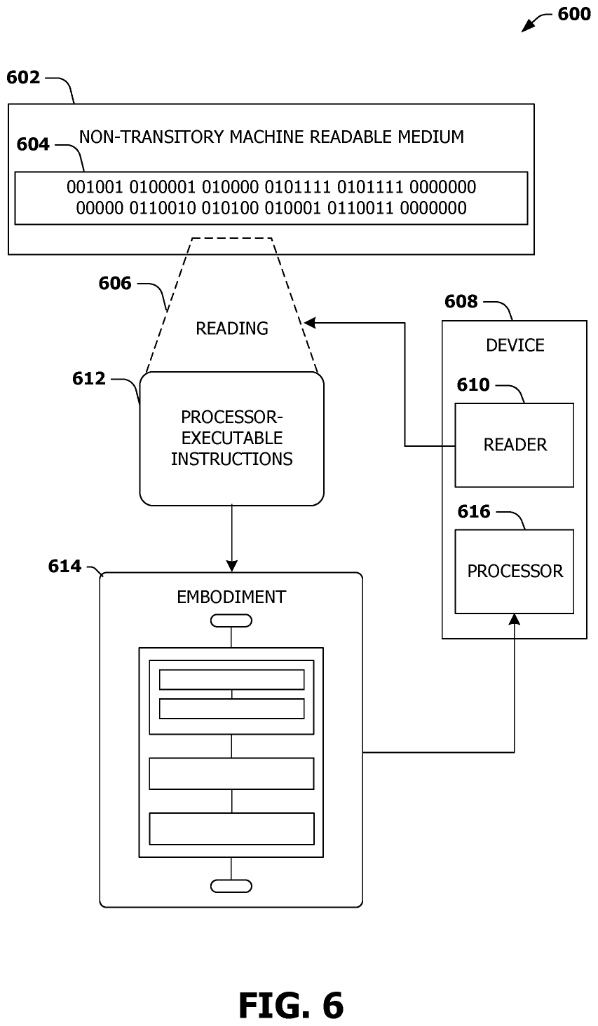

FIG. 6 is an illustration of a scenario 600 involving an example non-transitory machine readable medium 602. The non-transitory machine readable medium 602 may comprise processor-executable instructions 612 that when executed by a processor 616 cause performance (e.g., by the processor 616) of at least some of the provisions herein (e.g., embodiment 614). The non-transitory machine readable medium 602 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disc (CD), digital versatile disc (DVD), or floppy disk). The example non-transitory machine readable medium 602 stores computer-readable data 604 that, when subjected to reading 606 by a reader 610 of a device 608 (e.g., a read head of a hard disk drive, or a read operation invoked on a solid-state storage device), express the processor-executable instructions 612. In some embodiments, the processor-executable instructions 612, when executed, cause performance of operations, such as at least some of the example method 400 of FIG. 4, for example. In some embodiments, the processor-executable instructions 612 are configured to cause implementation of a system, such as at least some of the example system 501 of FIGS. 5A-5G, for example.

### 3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer and/or machine readable media, which if executed will cause the operations to be performed. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
receiving a query;
identifying a set of content items associated with the query;
determining, using a first language model, a plurality of sets of contextual information based upon the set of content items, wherein determining the plurality of sets of contextual information comprises:
determining a first set of contextual information based upon the query and a first content item of the set of content items; and
determining a second set of contextual information based upon the query and a second content item of the set of content items; and
determining, using a second language model, a response to the query based upon the plurality of sets of contextual information.

2. The method of claim 1, wherein:
determining the first set of contextual information comprises instructing the first language model to use the first content item to provide a second response to the query; and
determining the second set of contextual information comprises instructing the first language model to use the second content item to provide a third response to the query.

3. The method of claim 1, wherein:
identifying the set of content items associated with the query comprises:
identifying, using a content item retrieval tool, a pool of content items, wherein the pool of content items comprises the first content item;
determining an entity associated with the query;
determining, using a third language model and based upon the first content item, a first relevance classification indicative of whether the first content item is relevant to the entity; and
including the first content item in the set of content items based upon the first relevance classification indicating that the first content item is relevant to the entity.

4. The method of claim 3, wherein:
the pool of content items comprises a third content item; and
identifying the set of content items associated with the query comprises:
determining, using the third language model and based upon the third content item, a second relevance classification indicative of whether the third content item is relevant to the entity; and
not including the third content item in the set of content items based upon the second relevance classification indicating that the third content item is not relevant to the entity.

5. The method of claim 1, wherein:
determining the first set of contextual information and determining the second set of contextual information are performed concurrently.

6. The method of claim 1, comprising:
providing the response to the query for display on a client device.

7. The method of claim 6, wherein:
the query is received from the client device.

8. The method of claim 1, wherein:
the second language model is the same as the first language model.

9. The method of claim 1, wherein:
the second language model is different than the first language model.

10. A non-transitory machine-readable medium having stored thereon processor-executable instructions that when executed cause performance of operations, the operations comprising:
receiving a query;
identifying a set of content items associated with the query;
determining, using a first language model, a plurality of sets of contextual information based upon the set of content items, wherein determining the plurality of sets of contextual information comprises:
determining a first set of contextual information based upon the query and a first content item of the set of content items; and
determining a second set of contextual information based upon the query and a second content item of the set of content items; and
determining, using a second language model, a response to the query based upon the plurality of sets of contextual information.

11. The non-transitory machine-readable medium of claim 10, wherein:
determining the first set of contextual information comprises instructing the first language model to use the first content item to provide a second response to the query; and
determining the second set of contextual information comprises instructing the first language model to use the second content item to provide a third response to the query.

12. The non-transitory machine-readable medium of claim 10, wherein:
identifying the set of content items associated with the query comprises:
identifying, using a content item retrieval tool, a pool of content items, wherein the pool of content items comprises the first content item;
determining an entity associated with the query;
determining, using a third language model and based upon the first content item, a first relevance classification indicative of whether the first content item is relevant to the entity; and
including the first content item in the set of content items based upon the first relevance classification indicating that the first content item is relevant to the entity.

13. The non-transitory machine-readable medium of claim 12, wherein:
the pool of content items comprises a third content item; and
identifying the set of content items associated with the query comprises:
determining, using the third language model and based upon the third content item, a second relevance classification indicative of whether the third content item is relevant to the entity; and
not including the third content item in the set of content items based upon the second relevance classification indicating that the third content item is not relevant to the entity.

14. The non-transitory machine-readable medium of claim 10, wherein:
determining the first set of contextual information and determining the second set of contextual information are performed concurrently.

15. The non-transitory machine-readable medium of claim 10, the operations comprising:
providing the response to the query for display on a client device.

16. The non-transitory machine-readable medium of claim 15, wherein:
the query is received from the client device.

17. A computing device comprising:
a processor; and
memory comprising processor-executable instructions that when executed by the processor cause performance of operations, the operations comprising:
receiving a query;
identifying a set of content items associated with the query;
determining, using a first language model, a plurality of sets of contextual information based upon the set of content items, wherein determining the plurality of sets of contextual information comprises:
determining a first set of contextual information based upon the query and a first content item of the set of content items; and
determining a second set of contextual information based upon the query and a second content item of the set of content items; and
determining, using a second language model, a response to the query based upon the plurality of sets of contextual information.

18. The computing device of claim 17, wherein:
determining the first set of contextual information comprises instructing the first language model to use the first content item to provide a second response to the query; and
determining the second set of contextual information comprises instructing the first language model to use the second content item to provide a third response to the query.

19. The computing device of claim 17, wherein:
identifying the set of content items associated with the query comprises:
identifying, using a content item retrieval tool, a pool of content items, wherein the pool of content items comprises the first content item;
determining an entity associated with the query;
determining, using a third language model and based upon the first content item, a first relevance classification indicative of whether the first content item is relevant to the entity; and
including the first content item in the set of content items based upon the first relevance classification indicating that the first content item is relevant to the entity.

20. The computing device of claim 19, wherein:
the pool of content items comprises a third content item; and
identifying the set of content items associated with the query comprises:
determining, using the third language model and based upon the third content item, a second relevance classification indicative of whether the third content item is relevant to the entity; and
not including the third content item in the set of content items based upon the second relevance classification indicating that the third content item is not relevant to the entity.
